(19) United States
(12) Patent Application Publication
(10) Pub. No.: US 2013/0012153 A1
(43) Pub. Date: Jan. 10, 2013

(54) DEVICE FOR ACCESS TO AN ITEM OF ASSISTANCE AND EMERGENCY EQUIPMENT, AND A SYSTEM IMPLEMENTING SUCH DEVICES

(75) Inventors: Hubert Brosson, Paris (FR); Hubert Duverdier, Chatou (FR)

(73) Assignee: ATIALIS, Paris (FR)

(21) Appl. No.: 13/636,232

(22) PCT Filed: Mar. 24, 2011
(86) PCT No.: PCT/FR11/50630

§ 371 Date: Sep. 20, 2012

(30) Foreign Application Priority Data
Mar. 29, 2010 (FR) 1052274

(51) Int. Cl. H04M 11/04

(52) U.S. Cl. 455/404.1

(57) ABSTRACT

A device for access to first-aid emergency hardware, provided to be disposed at a given location, termed the emergency site, including: at least two compartments, each compartment being designed to receive at least one item of first-aid hardware and devised to be able to be opened independently, means of communication with a remote site, termed the central site, so as to request the opening of at least one of said compartments from a remote site, and for each of said compartments, locking means remotely and independently controlled so that each compartment can be opened independently of the other compartments.

The present invention relates to a device for access to an item of assistance and emergency equipment provided to be placed at a given location. It also relates to a system implementing such devices.

The field of the invention is the field of access to emergency response equipment and more particularly terminals for accessing the items of emergency equipment made available to the public in any type of public place.

### PRIOR ART

Currently few solutions exist making emergency equipment such as defibrillators available to the public. First emergency response action is essential, for example, for safeguarding the vital functions of an individual or to reduce the damage caused by an incident such as a fire, whilst waiting for intervention by qualified emergency personnel.

The public authorities wish to improve access to emergency equipment for the general public in order to improve the speed and quality of intervention for an individual in need of such equipment and/or emergency assistance with a view to reducing mortality and accident rates. The shorter the intervention time for delivering emergency care, the greater the chances of safeguarding the vital functions.

However, reducing the intervention time is directly correlated to the presence of emergency equipment for the general public and ease of access thereto. Moreover, the first emergency response equipment must be of various kinds, and comprise for example a kit for stopping burns, fire blankets, an extinguisher, a defibrillator, etc. It is impossible to predict what type of emergency equipment should be carried, or the location of use.

Moreover, access by the general public to emergency equipment of various kinds raises the question of surveillance, maintenance and securing this equipment, which is often costly, against attacks and various acts of vandalism.

To date no device for access to emergency equipment exists allowing suitable equipment to be made available to the public while protecting it and ensuring its functionality.

A purpose of the present invention is to overcome these drawbacks.

Another purpose of the invention is to propose a device for access to various kinds of first emergency response equipment while protecting this equipment against malicious acts.

Finally, another purpose of the invention is to propose better access to the use of the first emergency response equipment.

### SUMMARY OF THE INVENTION

The invention allows these goals to be achieved by a device for access to emergency equipment, provided to be placed at a given location, called an emergency response site, characterized in that it comprises:
at least two compartments, each of them being provided for receiving at least one item of emergency equipment and arranged so as to be able to be opened independently,
means of communication with a remote site, called central site, to request that at least one of said compartments is opened, and
for each of said compartments, locking means being able to be remotely and independently controlled so that each compartment can be opened independently of the others.

Thus, the device according to the invention allows selective access to emergency equipment located in a compartment.

Moreover, access to the emergency equipment for the general public is provided on request and after authorization, in a manner specific to each incident. As each compartment can be opened independently of the others, it is therefore possible to deliver the emergency equipment in a targeted fashion.

Finally, the emergency equipment is stored in compartments which are normally closed and will only open on request. Thus, the emergency equipment is protected against acts of vandalism.

The locking means, opening of which can be remotely controlled, can comprise at least one electromagnet, a sliding striker, a hooked striker, a pivoting catch.

Advantageously, at least one compartment is provided for receiving a defibrillation kit and at least one other compartment is provided for receiving fire-fighting means.

According to a particularly advantageous version of the device of the invention, the communication means can moreover comprise means of establishing and carrying out an audio and/or visual communication with the central site following a request for opening, and more particularly a communication in real time with an operator situated in the remote site.

Thus, the communication means can comprise one or more screens making it possible to see the operator in real time during the exchange, one or more cameras making it possible for the user to be seen in real time by the operator as well as one or more loudspeakers and one or more microphones making it possible for the user to speak with the operator in real time. The means of establishing communication can comprise wired means or wireless means via a telecommunication network.

The user is thus in contact with and assisted by an operator during access to the desired emergency equipment.

The operator can thus give instructions in real time to the user at the time of the emergency, which reassures the user and allows him to remain calm, enabling him to make better use of the emergency equipment.

Moreover, the operator can relieve the user of certain actions such as calling the professional emergency services, therefore making it possible for the user to concentrate better on the actions to be carried out.

Advantageously, the device according to the invention can moreover comprise geolocation means provided for signalling the position of said device to the central site or another site via a communications network.

Moreover, the device according to the invention can also comprise means of wireless connection to a device situated in proximity to said device. Such means of connection can incorporate, for example, so-called Wi-fi, Bluetooth, and other connections, with a view amongst other things, to transferring content of all types to this device, such as information relating to the use of emergency equipment.

Due to this specific capability, it is possible to ensure location via content relating to direction information for the purpose of reaching a given address. Thus, the device according to the invention also allows assistance to be given to people who are lost.

The device according to the invention can moreover comprise means of broadcasting audio and/or visual content via screens or loudspeakers.

The device can comprise means of storing content at the emergency response site.

The content can be transmitted from the central site or another remote site over a wired or wireless communications network.

Advantageously, at least one compartment of the device can comprise means for verifying the operational state of an apparatus when said apparatus is placed in said compartment.

According to a particular and non-limitative embodiment, the defibrillators comprise at least one light making it possible to indicate their operational state.

The compartment can then comprise an optical sensor or other, positioned so as to monitor this light and thus determine the operational state of the defibrillator in real time.

Moreover, the verification means can be coupled to a signalling/monitoring module provided for sending signals relating to the operational state of said apparatus to a remote management site.

According to a first version, the monitoring module makes it possible to indicate the operational state in real time.

According to another version, the monitoring module is suitable for analysing the information sent by the verification means and signalling only a malfunction or non-operational state.

According to yet another version, the monitoring module can be queried remotely in order to indicate the operational state of the emergency equipment.

Thus the device according to the invention makes it possible to ensure that the emergency equipment located in the compartments is in good operational order and can actually be used in an emergency.

The defibrillation means can comprise a defibrillator. The defibrillator can be placed in a suitable cover.

The fire-fighting means can comprise an extinguisher and/or a fire blanket as well as products for stopping or treating burns.

In a particular embodiment, the device according to the invention can be presented in the form of a terminal placed in a public location.

Depending on the functionalities implemented, this terminal can contain, non-exhaustively:
a base containing the different compartments,
an emergency call button,
at least one loudspeaker and a microphone,
a camera,
two LCD flat screens (vandal-proof) arranged vertically on each side of the terminal,
at least one antenna with wireless connection to a communication network allowing communication with the remote site,
at least one antenna with connection by Wifi or Bluetooth to a local appliance, and
electronic and/or computer communication interfaces.

According to another aspect of the invention, a system for accessing emergency equipment is proposed comprising:
several devices allowing access to the emergency equipment according to the invention, each being placed on a site, called an emergency response site,
communication means located at a so-called central site, remote from said emergency response sites, said communication means being linked with said devices via at least one communication network.

The central site comprises moreover means for remotely controlling the opening of a compartment of an emergency response device following a request.

Other advantages and characteristics of the invention will become apparent on examination of the detailed description of an embodiment which is in no way limitative, and the attached diagrams, in which

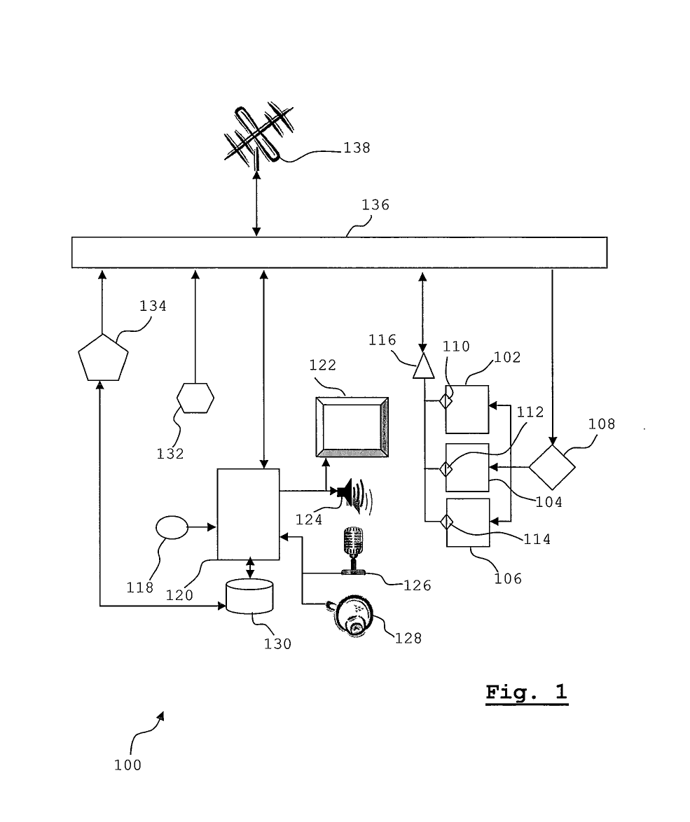

FIG. 1 is a block diagram of a device according to the invention;

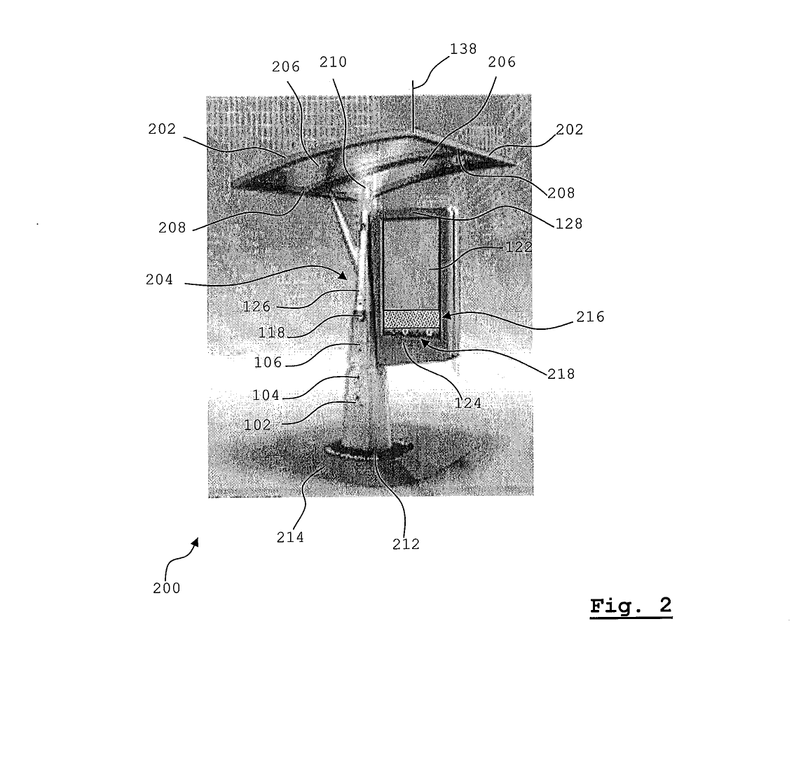

FIG. 2 is a diagrammatic representation of a device according to the invention shown in the form of a terminal; and

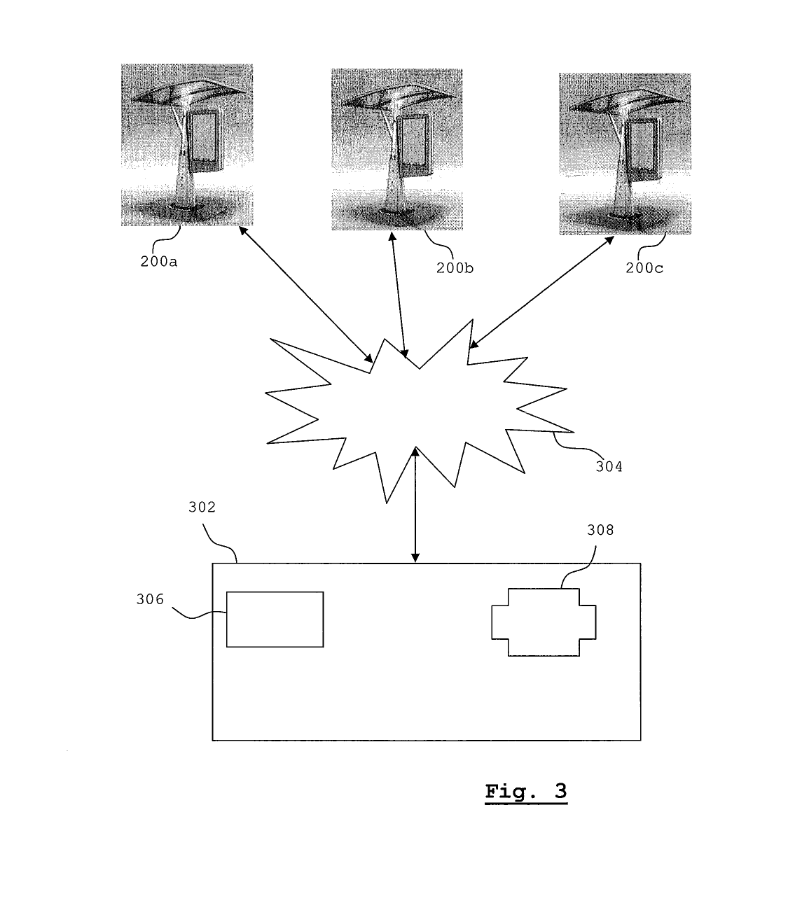

FIG. 3 is a diagrammatic representation of a system according to the invention implementing several devices according to the invention.

In the figures the elements common to several figures retain the same reference numbers.

FIG. 1 is a block diagram of an example of a device 100 for accessing the first emergency response equipment according to the invention.

The device 100 comprises three compartments 102, 104 and 106, provided for containing emergency equipment such as a defibrillator, an extinguisher, etc.

Each compartment is locked. Each compartment can be opened remotely, in a selective and individual manner, using a management module 108 linked to the compartments 102-106. The management module is linked to the locking means (not shown) of each of the compartments 102-106 which can be remotely controlled. These locking means can, for example, comprise electrical locking means using cylinders or electromagnets. These types of locking means are known to a person skilled in the art.

Each compartment 102-106 comprises a sensor, 110-114 respectively, arranged in the compartment 102-106 in order to pick up signals relating to the operational state of an apparatus placed in the compartment 102-106. The sensors 110-114 are linked to a signalling/monitoring module 116, which allows the operational state of each of the apparatus placed in each compartment, to be signalled individually at any moment.

Moreover, the device 100 comprises a call button 118 linked to a communication module 120 which allows a call to a remote site to be generated.

Moreover, the device 100 comprises at least one visual display screen 122, at least one loudspeaker 124, at least one microphone 126 and at least one camera 128 which are managed by the communication module in order to establish and carry out an audiovisual communication in real time with an operator situated at a remote site, which is called a central site in the remainder of the description.

The visual display screen 122 and the loudspeaker 124 are moreover arranged to broadcast content which can either be broadcast in real time or pre-recorded in storage means 130.

Moreover, the device 100 comprises a geolocation module 132 making it possible to determine and transmit data relating to the location of the device 100.

Furthermore, the device 100 also comprises a module 134 for connecting to appliances located in proximity to the device 100 via a Wifi, Bluetooth or other connection for downloading content recorded in storage means 130. Such a module 134 can also serve as connection point to a network of internet type for the appliances in question in order to access route data or other.

Finally, the device 100 comprises an interface 136 for managing communications and an antenna 138 for receiving and transmitting signals exchanged with a central site via a wave communications network or with a local appliance. Thus, in the example shown in FIG. 1, the management interface 136 is linked to the common antenna 138, the communication module 120, the geolocation module 130, the local connection module 134, the signalling module 116 and the management module 108 for opening the compartments 102-106. The management interface 136 makes it possible to direct the different signals received by the antenna 138 to the different modules and to transmit the signals emitted by the different modules to the antenna 138.

The operation of the device 100 will now be described. When an emergency occurs in proximity to the device 100, a user actuates the call button 118. The call signal is managed by the communication module 120, then the management interface 136 and transmitted by the antenna 138 to the central site. An audiovisual communication is established between the device 100 and the central site by use of the antenna 138, the interface 136 and the communication module 120. Using the microphone 126, the user can then speak to an operator whose image is displayed on the visual display screen 122. The user also hears the operator by means of the loudspeaker 124. The operator can also see the user by means of the camera 128.

The user then indicates to the operator the reason for his call and the equipment he needs for the first emergency response actions.

The operator then transmits an opening signal which comprises an indication as to the compartment concerned. This signal is received by the antenna 138 then by the management interface 136. The management interface 136 transmits the signal to the management module 108 for opening compartments 102-106. Once received, the module 108 analyses the opening signal, determines the compartment to be opened and initiates the opening of the compartment.

The user then has access to the equipment located in the compartment and can use it. During this time, the operator can reassure the user, calming him down and assisting him by alerting the emergency services on his behalf. The user can thus concentrate entirely on first emergency response actions.

Moreover, in order to determine the location of the device, the operator transmits a request to receive location data. This request is received by the antenna 138, then the management interface 136. The management interface 136 transmits the request to the geolocation module 132. In response to this request, the geolocation module 132 transmits location data, which is transmitted by the management interface 136, then the antenna 138, to the central site.

When the device 100 is not in use, content stored in storage means is disseminated via the screen 122 and the loudspeaker 124.

Moreover, the stored content can also be transferred to appliances local to the device 100 using a Bluetooth or Wifi connection, amongst others, ensured by the local connection module 134.

This content can relate to route data, data relating to training in the use of the emergency equipment for the general public, audiovisual content or others.

In addition, each compartment 102-106 comprises a sensor 110-114 arranged to receive signals relating to the operational state of an apparatus placed in this compartment 102-106, for example a defibrillator.

The signals picked up by these sensors 110-114 are transferred to a signalling/monitoring module 116, which analyses these signals and allows the operational state of the apparatus arranged in the compartments 102-106 to be determined. At regular intervals, the module 116 transmits to the central site data relating to the operational state of the apparatus located in the compartments 102-104.

Each compartment 102-106 is sealed and is produced in a material which is resistant to acts of vandalism. Each compartment can be produced from stainless steel or in corrugated steel, the stainless steel being pre-treated against rust. Each compartment can comprise one or more seals.

FIG. 2 is a diagrammatic representation of a device according to the invention presented in the form of a terminal 200.

This terminal 200 is equipped with a 46-inch (i.e. 105 cm×60 cm) LCD screen type 122 placed vertically on the side of the terminal. The bottom of the screen 122 is placed at a height of 110 cm from the ground. In addition, the call button 118 is placed at a height of 105 cm. The terminal 200 is protected from bad weather by a shield 202 placed at the level of its upper part and supported by a load-bearing column 204. The upper shield 202 is presented in the form of a roof incorporating one or more photovoltaic panels 206 making it possible to supply a part of the terminal with electricity.

The terminal comprises moreover LEDs 208 arranged on the roof 202 and allowing the terminal 200 site to be lit at night. The terminal also comprises an emergency rotating light 210.

The terminal contains in its lower part a base 212 called a “plate” making it possible to attach the terminal 200 to the ground. A nonslip surface covering 214 is arranged around the terminal 200.

Furthermore, the screen 122 contains a touch zone 216 and control buttons 218 arranged so that a user can interact with the terminal 200 and/or the screen 122.

FIG. 3 shows a system 300 according to the invention.

The system 300 comprises a central module 302 located at a central site. The system comprises moreover, non-limitatively, three terminals 200a-200c which offer access to emergency equipment for the general public placed on three emergency response sites. The central module 302 is in contact with each of the emergency response terminals 200a-200c via a wireless communications network 304.

The central module 302 comprises audio-visual communication means 306 making it possible to carry out audio-visual communications, in real time, between a user situated at an emergency response site and one or more operators situated at the central site. The central module comprises moreover means 308 for transmitting a request to open a compartment of a terminal 200a-200c.

Of course, the invention is not limited to the examples detailed above.

1. A device for access to first emergency response equipment, provided to be placed at a given location, called an emergency response site, comprising:
at least two compartments, each of the compartments being provided for receiving at least one item of first emergency response equipment and arranged to be able to be opened independently,
means of communication with a remote site, called central site, for requesting the opening of at least one of said compartments from said central site, and
for each of said compartments, locking means being able to be remotely and independently controlled so that each compartment can be opened independently of the other compartments.

2. The device according to claim 1, characterized in that the communication means include moreover means for establishing and carrying out an audio and/or visual communication with the remote site following a request for opening

3. The device according to claim 1, characterized in that it moreover comprises geolocation means provided for signalling the position of said device to the central site or another site via a communication network.

4. The device according to claim 1, characterized in that it comprises moreover means for wireless connection to an appliance situated in proximity to said device.

5. The device according to claim 1, characterized in that it comprises moreover means for broadcasting audio and/or visual content.

6. The device according to claim 1, characterized in that at least one compartment comprises means for verifying the operational state of an apparatus when said apparatus is arranged in said compartment.

7. The device according to claim 6, characterized in that the verification means are coupled to a signalling module provided for signalling the operational state of said apparatus to a remote management site.

8. The device according to claim 1, characterized in that the first emergency response equipment item comprises a defibrillator arranged in a first compartment.

9. The device according to claim 1, characterized in that the first emergency response equipment item comprises an extinguisher and/or a fire blanket arranged in a second compartment.

10. The device according to claim 1, characterized in that it is presented in the form of a terminal arranged in a public place.

11. A system for access to first emergency response equipment items, said system comprising:
several devices for access to first emergency response equipment according to the invention, each being arranged on a site, called emergency response site;
communication means arranged at a site, called central site, remote from said emergency response sites, said communication means being linked with said devices via at least one communication network; and
means for remotely controlling the opening of a compartment of an emergency device following a request.
